(19) United States
(12) Patent Application Publication
(10) Pub. No.: US 2011/0168881 A1
(43) Pub. Date: Jul. 14, 2011

(54) PLASMA-BASED DIRECT SAMPLING OF MOLECULES FOR MASS SPECTROMETRIC ANALYSIS

(76) Inventors: Ralph E. Sturgeon, Orleans (CA); Zoltan Mester, Ottawa (CA)

(21) Appl. No.: 13/119,578

(22) PCT Filed: Oct. 2, 2009
(86) PCT No.: PCT/CA09/01409

§ 371 Date: Mar. 17, 2011

Related U.S. Application Data
(60) Provisional application No. 61/136,802, filed on Oct. 3, 2008.

(51) Int. Cl. H01J 49/26

(52) U.S. Cl. 250/282; 250/288

(57) ABSTRACT

A plasma-based dielectric barrier discharge (DBD) ion source is configured for flowing afterglow sampling and ionization of analytes. A method of direct sampling for mass spectrometric analysis includes providing an afterglow from a dielectric barrier discharge (DBD) plasma device, directing the afterglow with a flow of heated plasma support gas to a sample positioned externally to the DBD device, ionizing at least a portion of the sample with the afterglow and heated gas, and, analyzing ionized species from the sample in a mass spectrometer. A system for mass spectrometric analysis of a sample includes a mass spectrometer having an entrance aperture, and, a dielectric barrier discharge (DBD) ion source having a heated plasma support gas for directing DBD afterglow to a sample positioned between the DBD ion source and the entrance aperture of the mass spectrometer.

### CROSS-REFERENCE TO RELATED APPLICATIONS

This application claims the benefit of U.S. Provisional Patent Application Ser. No. 61/136,802 filed Oct. 3, 2008, the entire contents of which his hereby incorporated by reference.

### FIELD OF THE INVENTION

The present invention is related to plasma-based systems and methods for direct sampling for mass spectrometric analysis.

### BACKGROUND OF THE INVENTION

The development of atmospheric pressure ionization sources for organic mass spectrometry has been in the focus of analytical developments for over two decades. New, soft ionization approaches, including electrospray (ESI) and matrix assisted laser desorption ionization (MALDI), were introduced in the 1980's to enable analysis of non-volatile organic compounds.

In the last few years, a second wave of development has started aiming at the removal and ionization of compounds directly from solid surfaces. These techniques include direct analysis in real time (DART) and desorption electrosrpay ionization (DESI). These techniques enabled users to directly interrogate solid samples (surfaces) for the presence of compounds of interest.

An early atmospheric pressure desorption-ionization approach was reported by Tsuchiya and co-workers. Using a solvent drop exposed to the effluent argon from a corona discharge, the analyte signal could be detected. In 2004, Cooks and co-workers introduced the concept of desorption-electrospray ionization (DESI) and in 2005 Cody et al. the direct ionization real time (DART). DESI employs high velocity droplets generated by ESI to impact the studied surface, stripping away molecules and ionizing them. In DART, heated flows of helium or nitrogen support corona discharges are used to produce ions and other excited species which are then directed through a set of lenses such that the heated stream of active species achieves both desorption and ionization.

Recently, Andrade et al. (Andrade 2008) described flowing afterglow-atmospheric pressure glow discharge (FA-APGD) used in the direct analysis of solid samples. Also, certain configurations of dielectric barrier discharge (DBD) ion sources have been used for direct mass spectrometric analysis of solid samples (Na 2007a; Na 2007b). However, these methods and systems have limitations making them unsuitable for convenient sampling from a variety of substrates.

There remains a need for an effective method and system for direct sampling, especially of solid samples, for analysis by mass spectrometric analysis.

### SUMMARY OF THE INVENTION

In the present invention, a plasma-based dielectric barrier discharge (DBD) ion source is configured for flowing afterglow sampling and ionization of analytes.

Thus, in one aspect of the present invention, there is provided a method of direct sampling for mass spectrometric analysis comprising: providing an afterglow from a dielectric barrier discharge (DBD) plasma device; directing the afterglow with a flow of heated plasma support gas to a sample positioned externally to the DBD device; ionizing at least a portion of the sample with the afterglow and heated gas; and, analyzing ionized species from the sample in a mass spectrometer.

In another aspect of the present invention, there is provided a system for mass spectrometric analysis of a sample comprising: a mass spectrometer having an entrance aperture; and, a dielectric barrier discharge (DBD) ion source having a heated plasma support gas for directing DBD afterglow to a sample positioned between the DBD ion source and the entrance aperture of the mass spectrometer.

DBD devices are plasma-based ion sources in which an alternating voltage applied between two electrodes separated by a dielectric barrier produces a plasma in a gas space between the electrodes. The plasma has a large number of high energy species which may be used to ionize and volatilize/desorb samples. When the DBD device is configured in a so-called “gun” configuration in which a moving plasma support gas directs the plasma afterglow to an external sample, it has now been found that it is necessary to heat the plasma support gas in order to provide sufficient desorption/volatilization of the sample in order to get a signal in a mass spectrometer. Preferably, the plasma support gas is heated to a temperature of 50° C. or greater, for example, a temperature in a range from about 50° C. to about 300° C. or a temperature in a range from about 100° C. to about 250° C. To heat the plasma support gas any suitable method may be used. The plasma support gas may be heated at the gas source or at any point along the way to the sample. Conveniently, the plasma support gas may be heated while resident in the DBD device. Some examples of suitable heating devices include heating tapes, heating coils and ovens. Also, by passing sufficient current into the DBD device it is possible for the plasma to become self-heated obviating the need for an additional heating device.

The plasma support gas is preferably an inert gas, for example, helium, argon, nitrogen, neon or a mixture thereof. Helium, argon or a mixture thereof is preferred. Any suitable flow rate of gas may be used. A flow rate in a range of from about 1-5 L/min is generally suitable, more particularly 2-4 L/min. To further assist in volatilization/desorption of the sample, a reagent gas may be introduced into the plasma support gas flow. The nature of such reagent gases depends to some extent on the nature of the sample being analyzed. Some examples of reagent gases include water, carbon dioxide, carbon monoxide, methane, isobutane, ammonia, and hydrogen.

Unlike many prior art methods and systems for direct sampling, the DBD device can be used in conjunction with standard mass spectrometers without peripheral aids for collecting analyte. For example, it is unnecessary in the present invention to use magnetic lenses or applied vacuum to help collect ionized analyte in the entrance aperture of a mass spectrometer. The design of the DBD device and its configuration in the system permit effective passive collection of the ionized analyte in the mass spectrometer. Thus, the sample, and sample substrate, is external to the DBD device. The DBD device may be oriented at any angle in respect of the normal of the front face of the mass spectrometer where the entrance aperture is located. In a preferred embodiment, the DBD device is oriented at an oblique angle in respect of the sample and the front face of the mass spectrometer where the entrance aperture is located. An angle in a range of about 20° to about 70° in respect of a normal to the front face of the mass spectrometer is of particular note.

Any sample amenable to analysis by mass spectrometry may be sampled using the method or system of the present invention. Solid samples or samples incorporated on solid substrates are preferred. Of particular note are organic compounds, for example, drugs (e.g. pharmaceuticals, illicit drugs), explosives, organometallic compounds, agrochemicals and chemical warfare agents.

The present invention advantageously permits the use of any substrate for supporting a sample. Since the sample and substrate are external to the DBD device, no specialized substrate is required. Thus, samples can be directly sampled from original objects, for example, objects found at crime scenes or confiscated from suspected criminals. Further, a chemical of interest could be sampled using swabs, wipes, etc. commonly used in forensic, environmental and hygienic sampling to sample from large surfaces. Furthermore, the present invention provides faster and more convenient analysis than prior art methods and systems and any standard mass spectrometer can be used in the present invention. The present invention further provides improved sensitivity over such methods as DART, particularly for drug detection.

The design of the DBD device has an important effect on the performance of the method and system of the present invention. The DBD device is provided in a so-called “gun” configuration in which the DBD ion source and the heated plasma support gas are embodied in one apparatus for directing the flowing afterglow of the DBD ion source to an external sample. Thus, the DBD device preferably comprises a generally tubular body surrounding a discharge electrode, with heated plasma support gas flowing through the device to carry the afterglow of the discharge out through an exit orifice directed towards the externally located sample. For simplicity, the tubular body preferably acts as a ground electrode, and a dielectric barrier, preferably in the form of a tube, separates the discharge electrode from the grounded body. The body preferably comprises a metal. The discharge electrode preferably comprises a metal, preferably in the form of a solid rod. To separate the plasma support gas from the grounded body, a second dielectric barrier, preferably a second tube, may be used. The heated plasma support gas preferably flows between the two dielectric barriers so that the dielectric barriers separate the plasma support gas from the ground and discharge electrodes.

The discharge is powered by a switching unit driven by two high voltage power supplies biased between +/−1000-10,000 V and modulated as a wave by a function generator. The discharge power is preferably in a range of 20-100 W, for example about 50 W, and the output current in a range of 10-50 mA.

Further features of the invention will be described or will become apparent in the course of the following detailed description.

### BRIEF DESCRIPTION OF THE DRAWINGS

In order that the invention may be more clearly understood, embodiments thereof will now be described in detail by way of example, with reference to the accompanying drawings, in which:

FIG. 1 is a schematic drawing of a cross-section of a first embodiment of a dielectric barrier discharge (DBD) ion source useful in a method and system of the present invention;

FIG. 2 is a schematic drawing of a cross-section of a second embodiment of a dielectric barrier discharge (DBD) ion source useful in a method and system of the present invention;

FIG. 3A and FIG. 3B depict emission spectra comparing the DBD ion sources depicted in FIG. 1 and FIG. 2;

FIG. 4 is a schematic drawing of a first embodiment of a system of the present invention in which an afterglow of a DBD ion source is directed to a solid sample proximal the entrance aperture of a mass spectrometer;

FIG. 5 is a schematic drawing of a second embodiment of a system of the present invention in which an afterglow of a DBD ion source is directed to a solid sample proximal the entrance aperture of a mass spectrometer;

FIG. 6 is a mass spectrum of acetaminophen from a solid Tylenol™ sample analyzed in accordance with a method of the present invention;

FIG. 7 is a mass spectrum of ibuprofen from a solid Advil™ sample analyzed in accordance with a method of the present invention;

FIG. 8 is a mass spectrum of B vitamins from a solid vitamin B sample analyzed in accordance with a method of the present invention;

FIG. 9 is a mass spectrum of triacetone triperoxide (TATP) analyzed in accordance with a method of the present invention;

FIG. 10 is a mass spectrum of trinitrotoluene (TNT) analyzed in accordance with a method of the present invention; and,

FIG. 11 is a mass spectrum of cocaine on Canadian bank notes analyzed in accordance with a method of the present invention.

### DESCRIPTION OF PREFERRED EMBODIMENTS

### Reagents and Samples:

High purity argon and helium were obtained from MEGS Specialty gases (Ottawa, ON). Test samples of various compounds were all reagent grade purity or better, sourced from various chemical suppliers. Samples included acetaminophen, ibuprofen, B-vitamins, or tablet formulations of these compounds in the form of Tylenol™, Advil™ and B-vitamins. Samples also included triacetone triperoxide (TATP), trinitrotoluene (TNT) and cocaine, or articles having trace amounts of these compounds thereon.

### Mass Spectrometry:

Mass spectrometric analyses were undertaken using an API 300 mass spectrometer (Sciex, Toronto, Canada) in MS mode of operation. The ion source of the mass spectrometer was replaced with a DBD ion source described below.

### Example 1

### First Embodiment of a DBD Ion Source

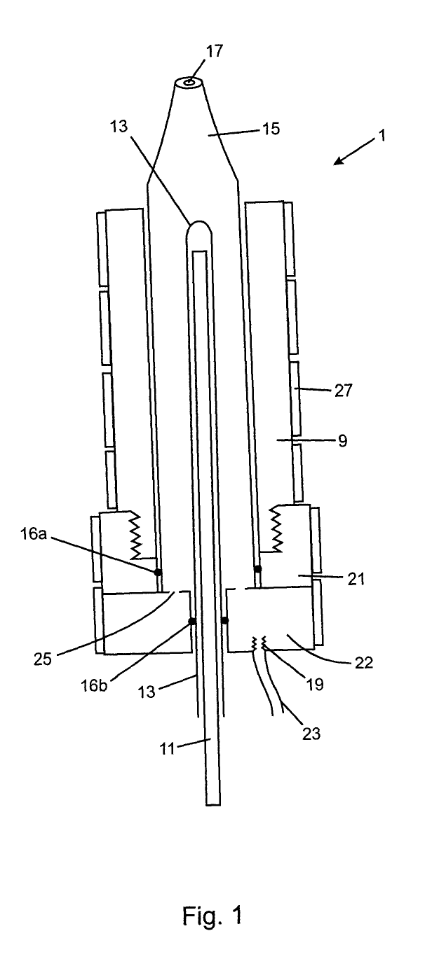

As illustrated in FIG. 1, one embodiment of an ionization source is a cylindrical dielectric barrier discharge (DBD) device 1. The DBD device 1 is fabricated from brass, comprising body 9 about 15 cm long×4 cm outer diameter (OD). Discharge electrode 11 is a 17.0 cm long aluminum rod (0.32 cm OD) enclosed in thin-walled (0.35 cm ID, 0.45 cm OD) inner quartz tube 13 sealed at one end which serves as a dielectric barrier partitioning it from the grounded wall of body 9. The total length of the aluminum rod in the discharge area is 8.0 cm. A second concentric 11.4 cm long outer quartz tube 15 (1.27 cm OD, 1.07 cm ID) surrounds the sheathed discharge electrode and serves to support Ar or He discharge. Outer quartz tube 15 is drawn to a cone with a 1 mm diameter exit orifice 17 at the exposed end, the cone protruding 2 cm from the brass body of the DBD device. Outer quartz tube 15 is centered and sealed with the aid of “O”-rings 16a,16b in base 21 of DBD body 9. Discharge gas (e.g. Ar or He) is supplied to the DBD device at 2-4 L/min and controlled with use of a rotameter flow meter. The discharge gas in gas supply line 23 passes through Swagelok™ fitting 19 into chamber 22 of base 21 and then passes out of the chamber through annular opening 25 into outer quartz tube 15.

The entire brass body of the DBD device is wrapped in heater tape 27 and maintained at a temperature of approximately 160° C. which permits the effluent Ar or He gas to reach a temperature of approximately 100° C. This facilitates desorption of analytes from various test substrates into the flowing afterglow of the DBD plasma.

The discharge is powered by a Direct Energy Inc. (Ft. Collins, Colo.) model GRX-3 switching unit driven by two 25 W Stanford Research Systems (Sunnyvale Calif.) model PS325 high voltage power supplies biased between +/−1325 V and modulated as a 5 kHz square wave by a Stanford Research Systems function generator (model DS340). It is estimated that the discharge power is in the region of 20 W and the out put current is 10-50 mA.

### Example 2

### Second Embodiment of a DBD Ion Source

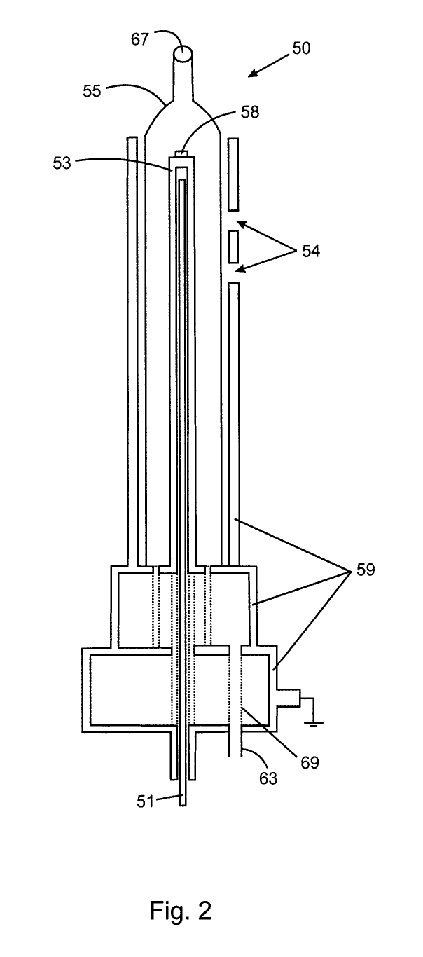

As illustrated in FIG. 2, another embodiment of an ionization source is a cylindrical dielectric barrier discharge (DBD) device 50 constructed in a similar manner as the device depicted in FIG. 1. The DBD device 50 is fabricated from brass, comprising a grounded body 59 having the same overall dimensions as in the device of FIG. 1. Discharge electrode 51 is an aluminum rod having the same dimensions as in FIG. 1 enclosed in thin-walled inner quartz tube 53 having the same dimensions as in FIG. 1. The inner quartz tube is sealed at one end with silicone plug 58. A second concentric outer quartz tube 55 is the same length as in FIG. 1 but is narrower having an outer diameter (OD) of 0.9 cm and an inner diameter (ID) of 0.7 cm. The outer quartz tube surrounds the sheathed discharge electrode and serves to support Ar or He discharge. Discharge gas in gas supply line 63 passes through Swagelok™ fitting 69 and passes through the device in a similar manner as depicted in FIG. 1. The entire brass body of the DBD device is wrapped in heater tape (not shown). Observation ports 54 are useful for collecting emission measurements from the device. Power and other parameters are as described in reference to FIG. 1.

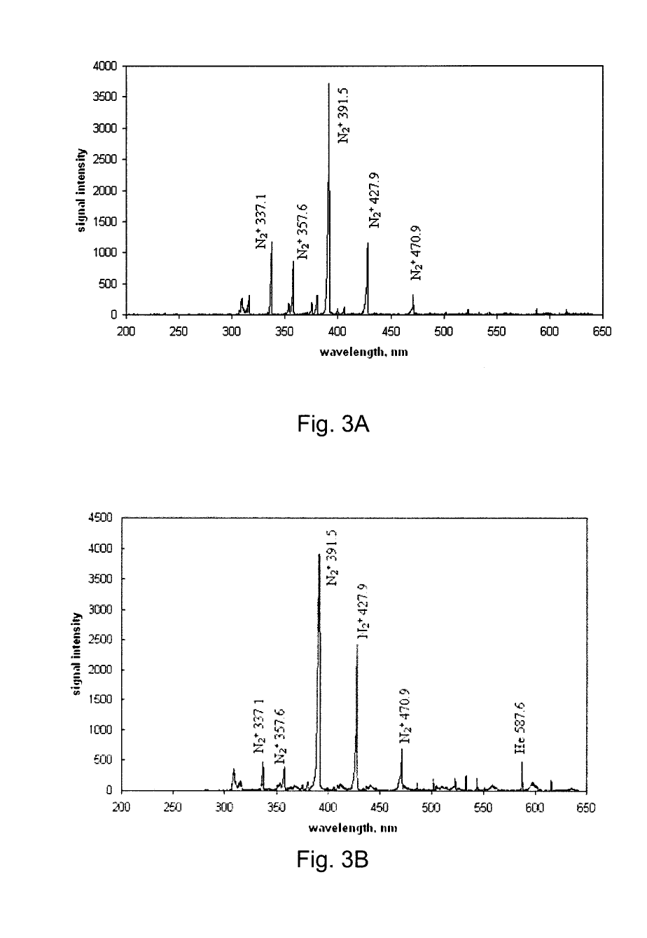

Referring to FIG. 3, emission spectra were obtained from the devices of FIGS. 1 and 2. FIG. 3A is the emission spectrum from the device of FIG. 1, and FIG. 3B is the emission spectrum from the device of FIG. 2. All emission spectra were collected under the following conditions: He flow=2 litres/min; plasma source frequency (f)=3 kHz; high voltage (HV) applied to discharge electrode=5 kV; and, brass body resistively heated to a temperature of 160° C. to give gas temperature=100° C. Integration time was different for each with the spectrum from device of FIG. 1 having an integration time of 10,000 ms and the spectrum from device of FIG. 2 having an integration time of 3,000 ms.

In comparing the two emission spectra, it is evident that He 587.6 peak is visible in the spectrum of the device of FIG. 2 but not of FIG. 1. The device of FIG. 2 having a narrower outer quartz tube is a more optimal design than the device of FIG. 1.

### Example 3

### First Embodiment of a Sampling Procedure

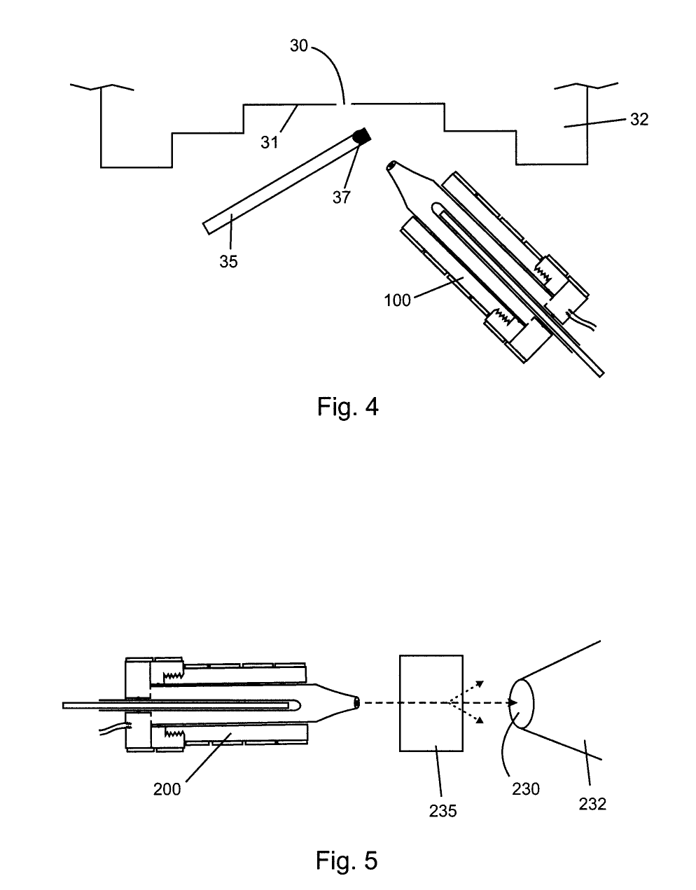

Referring to FIG. 4, a DBD ion source 100 is positioned in front of mass spectrometer entrance aperture 30 about 1.5 cm from front plate 31 of mass spectrometer 32 to permit space for insertion of substrate 35 on which solid sample 37 is loaded for desorption and ionization. The tip of the source is positioned on-axis at 45° about 1.5 cm from the entrance aperture of the mass spectrometer. Plasma from the DBD device is readily initiated by application of AC voltage to the discharge electrode while the body is held at ground for ease of operation. The effective discharge length is approximately that of the discharge electrode.

Samples are loaded as solutions (typically 10 μl volumes) of the test materials onto a substrate (e.g. a quartz “spoon”) on which they are conveniently dried. The spectrometer is set up to scan the m/z region of interest (typically ±50 u on either side of the target) and the quartz spoon manually positioned between the exit orifice of the DBD device and the entrance aperture of the API mass spectrometer (see FIG. 4), allowing the heated afterglow to impinge on the test material loaded surface, desorbing the analyte and ionizing it. Passive sampling of the beam into the spectrometer is undertaken in the absence of a system of high voltage lenses. The position of the test material on the quartz spoon relative to the DBD exit orifice and the flow rate of Ar or He were optimized.

### Example 4

### Second Embodiment of a Sampling Procedure

Referring to FIG. 5, a DBD ion source 200 is positioned in front of and about 1.5 cm away from mass spectrometer entrance aperture 230 of mass spectrometer 232 to permit space for insertion of substrate 235 on which an analyte is present for desorption and ionization. The tip of the source is positioned on the normal from the front face of the entrance aperture of the mass spectrometer. Plasma from the DBD device is readily initiated by application of AC voltage to the discharge electrode while the body is held at ground for ease of operation. The effective discharge length is approximately that of the discharge electrode.

Substrates carrying analytes to be analyzed may be inserted directly between the ion source and entrance aperture of the mass spectrometer (see FIG. 5). The spectrometer is set up to scan the m/z region of interest (typically ±50 u on either side of the target). The heated afterglow from the DBD device is allowed to impinge on the substrate carrying the analyte, desorbing the analyte and ionizing it. Passive sampling of the beam into the spectrometer is undertaken in the absence of a system of high voltage lenses.

### Example 5

### Analysis of Acetaminophen, Ibuprofen and Vitamin B

The DBD device of Example 1 and sampling procedure of Example 3 were used to analyze samples for acetaminophen, ibuprofen or vitamin B. Mass spectrometry lens voltages were optimized using acetaminophen containing tablets held in fixed position in front of the ion source. No MS signal of the analyte could be obtained without an operational plasma and plasma support gas flow rates in the L/min region with heating.

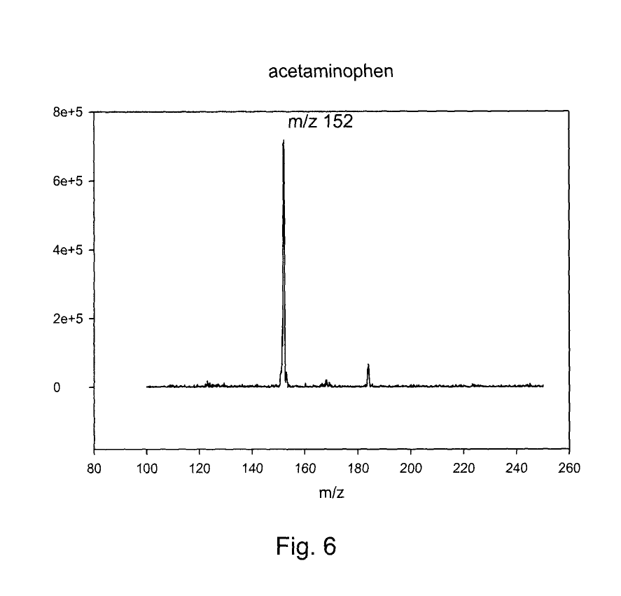

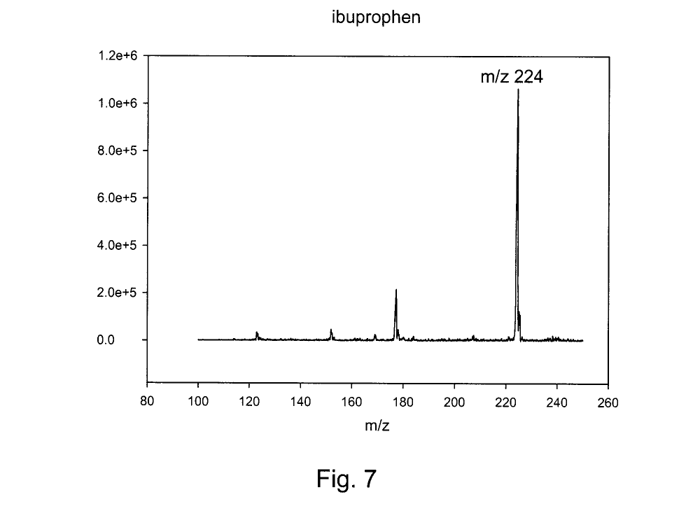

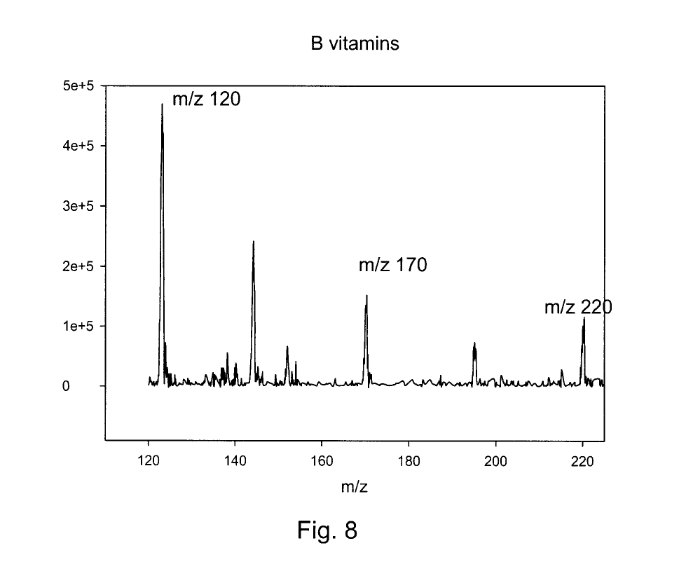

The results for three different test materials are shown in FIGS. 6-8. These figures show typical mass spectral signals obtained in scan mode for Tylenol™ (acetaminophen, FIG. 6), Advil™ (ibuprofen, FIG. 7) and vitamin B pills (FIG. 8). The absolute detection limits of the system were in the low picoM region for the analytes studied.

### Example 6

### Analysis of Triacetone Triperoxide (TATP), Trinitrotoluene (TNT) and Cocaine

The DBD device of Example 1 and sampling procedure of Example 4 were used to analyze samples for triacetone triperoxide (TATP), trinitrotoluene (TNT) and cocaine. No MS signal of the analyte could be obtained without an operational plasma and plasma support gas flow rates in the L/min region with heating.

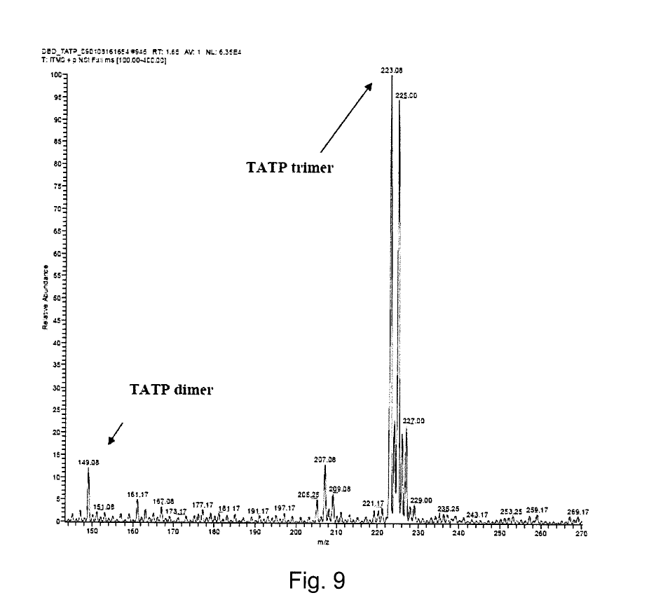

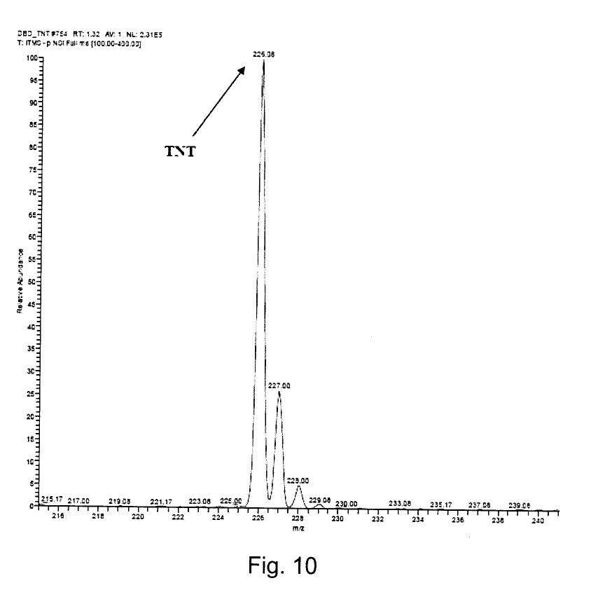

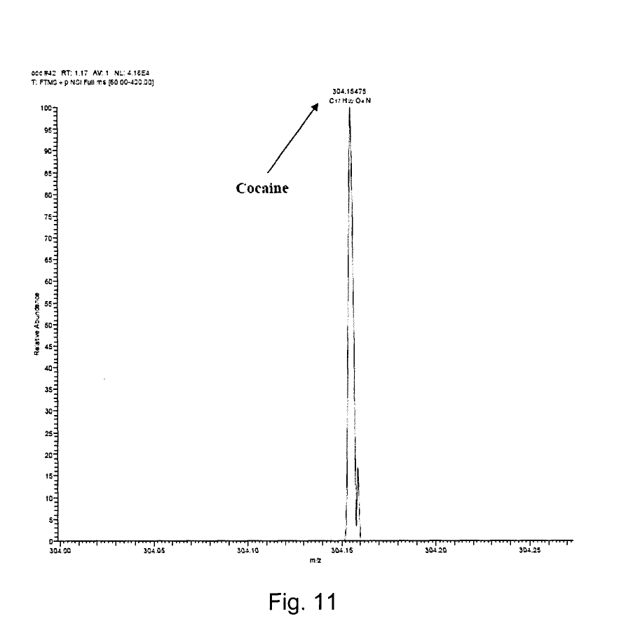

The results for three different test materials are shown in FIGS. 9-11. These figures show typical mass spectral signals obtained in scan mode for TATP (triacetone triperoxide, FIG. 9), TNT (trinitrotoluene, FIG. 10) and cocaine (FIG. 11). Both the TATP trimer and dimer were detected in the TATP sample (FIG. 9). The samples for FIG. 11 were Canadian bank notes on which ultra trace levels of the cocaine were detected. The absolute detection limits of the system were in the low picoM region for the analytes studied.

Examples 1-6 demonstrate the efficacy of the present device, method and system for direct mass spectrometric analysis of small amounts of analytes. Thus, in the present invention a plasma-based ion source is configured for flowing afterglow sampling and ionization of analytes lifted from the surfaces of solid substrates. A method of interrogating a sample for mass spectrometric analysis includes providing a plasma afterglow, directing the afterglow with a flow of heated carrier gas to a sample positioned externally to the plasma device, volatilizing and/or ionizing at least a portion of the sample with the afterglow and heated gas, and analyzing the volatilized and/or ionized sample in a mass spectrometer. The system is capable of direct analysis of solid, liquid and gaseous analytes. It has been demonstrated for the detection of active components in pharmaceutical formulations, drugs of abuse and explosives and is useful in many other classes of chemicals of interest.

### REFERENCES

The contents of the entirety of each of which are incorporated by this reference.
Andrade F J, Shelley J T, Wetzel W C, Webb M R, Gamez G, Ray S J, Hieftje G M. (2008) Anal Chem. 80:2646-2653.
Monagle M. (1999) U.S. Pat. No. 5,892,364 issued Apr. 6, 1999.
Musselman B D (2008) US Patent Publication 2008/0067359 published Mar. 20, 2008.
Na N, Zhang C, Zhao M, Zhang S, Yang C, Fang X, Zhang X. (2007a) J Am Soc Mass Spectrom. 18:1859-1862.
Na N, Zhao M, Zhang S, Yang C, Zhang X. (2007b) J Mass Spectrom. 42:1079-1085.
Zhu Z, Liu J, Zhang S, Na X, Zhang X. (2008) Spectrochimica Acta Part B. 63:431-436.

Other advantages that are inherent to the structure are obvious to one skilled in the art. The embodiments are described herein illustratively and are not meant to limit the scope of the invention as claimed. Variations of the foregoing embodiments will be evident to a person of ordinary skill and are intended by the inventor to be encompassed by the following claims.

1. A method of direct sampling for mass spectrometric analysis comprising: providing an afterglow from a dielectric barrier discharge (DBD) plasma device; directing the afterglow with a flow of heated plasma support gas to a sample positioned externally to the DBD device; ionizing at least a portion of the sample with the afterglow and heated gas; and, analyzing ionized species from the sample in a mass spectrometer.

2. The method according to claim 1, wherein the heated plasma support gas is at a temperature of 50° C. or greater.

3. The method according to claim 1, wherein the heated plasma support gas is at a temperature in a range of from 100° C. to 250° C.

4. The method according to claim 1, wherein the flow of heated plasma support gas is at an oblique angle in respect of the sample and a front face of the mass spectrometer and the angle is in a range of 20° to 70° in respect of a normal to the front face of the mass spectrometer.

5. The method according to claim 1, wherein the plasma support gas comprises helium, argon or a mixture thereof.

6. The method according to claim 1, wherein the sample is a solid.

7. The method according to claim 6, wherein the sample comprises a drug, an explosive, an organometallic compound, an agrochemical or a chemical warfare agent.

8. A system for mass spectrometric analysis of a sample comprising: a mass spectrometer having an entrance aperture; and, a dielectric barrier discharge (DBD) ion source having a heated plasma support gas for directing DBD afterglow to a sample positioned between the DBD ion source and the entrance aperture of the mass spectrometer.

9. The system according to claim 8, wherein the heated plasma support gas is at a temperature of 50° C. or greater.

10. The system according to claim 8, wherein the heated plasma support gas is at a temperature in a range of from 100° C. to 250° C.

11. The system according to claim 8, wherein the heated plasma support gas flows at an oblique angle in respect of the sample and a front face of the mass spectrometer and the angle is in a range of 20° to 70° in respect of a normal to the front face of the mass spectrometer.

12. The system according to claim 8, wherein the plasma support gas comprises helium, argon or a mixture thereof.

13. The system according to claim 8, wherein the sample is a solid.

14. The system according to claim 8, wherein the sample comprises a drug, an explosive, an organometallic compound, an agrochemical or a chemical warfare agent.

15. The system according to claim 8, wherein the DBD ion source comprises a device having generally tubular body acting a ground electrode surrounding a discharge electrode, the body and the discharge electrode separated by a dielectric barrier, the heated plasma support gas flowing through the device to carry the DBD afterglow out through an exit orifice directed towards the sample.

16. The system according to claim 15, wherein the body comprises brass.

17. The system according to claim 15, wherein the discharge electrode comprises an aluminum rod.

18. The system according to claim 15, wherein the dielectric barrier comprises a first quartz tube surrounding the discharge electrode.

19. The system according to claim 18, wherein the device further comprises a second quartz tube separating the first quartz tube from the body, the plasma support gas flowing between the first and second quartz tubes.

20. The system according to claim 15, wherein the device further comprises a heating tape wrapped around the body for heating the plasma support gas in the device.
